(19) United States
(12) Patent Application Publication
(10) Pub. No.: US 2026/0093022 A1
(43) Pub. Date: Apr. 2, 2026

(54) CONTROL METHOD, CONTROL DEVICE, AND CONTROL SYSTEM

(71) Applicant: Infineon Technologies AG, Neubiberg (DE)

(72) Inventors: Mathias Gangl, Graz (AT); Walther Pachler, Graz (AT); Christoph Hermann, Graz (AT); Dominic Peter Pirker, Graz (AT); Mario Reitbauer, Graz (AT)

(21) Appl. No.: 19/337,969

(22) Filed: Sep. 24, 2025

(30) Foreign Application Priority Data
Sep. 30, 2024 (DE) 102024209549.4

(51) Int. Cl. G01S 11/02; H04W 4/029; H04W 64/00

(52) U.S. Cl. CPC G01S 11/02; H04W 64/006; H04W 4/029

(57) ABSTRACT

A position dependent control method includes receiving a first part of a UWB packet from a first UWB transceiver via a first antenna of a second UWB transceiver, wherein the first antenna is located inside a barrier protected space, determining a first distance between the first UWB transceiver and the first antenna based on the first part of the UWB packet, receiving a second part of the UWB packet via a second antenna of the second UWB transceiver, wherein the second antenna is located outside the barrier protected space, determining a second distance between the first UWB transceiver and the second antenna based on the second part of the UWB packet, comparing the first distance with the second distance, and determining that the first UWB transceiver is inside the barrier protected space when the first distance is smaller than the second distance, and that otherwise the first UWB transceiver is outside the barrier protected space.

### REFERENCE TO RELATED APPLICATION

This application claims priority to German Application number 102024209549.4, filed on Sep. 30, 2024, the contents of which are hereby incorporated by reference in their entirety.

### TECHNICAL FIELD

The present disclosure relates to a position dependent control method, a control device, and a control system.

### BACKGROUND

In the prior art, some systems require a knowledge of a position of a device with respect to a closed structure, in particular whether the device is located inside or outside a barrier protected space, also referred to as inside-outside-detection (IO-detection for short), which may be a common problem.

For example, WO 2022/253949 A1 discloses a UWB localization device that is configured to determine a first time of arrival between a further device and a first antenna and a second time of arrival between the further device and a second antenna, wherein both antennas are located inside the device and separated from each other by a UWB shield that is meant to ensure that a UWB signal from the further device has an unshielded path only to either the first antenna or to the second antenna.

The determined first and second times of arrival are used to determine if the device is closer to the first antenna or to the second antenna.

However, the above described device has a complex and expensive setup that includes the UWB shield in combination with the two transceiver paths (for the first antenna and the second antenna).

### SUMMARY

A position dependent control method is provided. The method includes receiving a first part of an UWB packet from a first UWB transceiver via a first antenna of a second UWB transceiver, wherein the first antenna is located inside a barrier protected space, determining a first distance between the first UWB transceiver and the first antenna from the first part of the UWB packet, receiving a second part of the UWB packet from the first UWB transceiver via a second antenna of the second UWB transceiver, wherein the second antenna is located outside the barrier protected space, determining a second distance between the first UWB transceiver and the second antenna from the second part of the UWB packet, comparing a value of the first distance with a value of the second distance, and determining whether the first UWB transceiver is inside or outside the barrier protected space by determining that the first UWB transceiver is inside the barrier protected space if a result of the comparison indicates that the first distance is smaller than the second distance, and that otherwise the first UWB transceiver is outside the barrier protected space.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 shows a schematic illustration of a control device in accordance with various embodiments.

FIG. 2 shows a schematic illustration of a control device in accordance with various embodiments.

Each of FIGS. 3A to 3C illustrates a position dependent control method in accordance with various embodiments.

FIG. 4 illustrates a determining of a phase difference between parts of a control device in accordance with various embodiments.

FIG. 5 shows a flow diagram of a position dependent control method in accordance with various embodiments.

### DETAILED DESCRIPTION

The examples described herein provide a position dependent control method and a device and a system that are configured to execute the position dependent control method.

The position dependence may in various embodiments relate to a so-called inside-outside-detection (IO-detection; a detection of whether a device is located inside a barrier protected space or outside the barrier protected space).

Various embodiments may provide a control (e. g., of a function) based on whether a device (e. g., a UWB (ultra wide band) transceiver) is detected inside or outside the barrier protected space. For example, the barrier protected space may be a closed room (e. g., of a house or a vehicle), and a control of an opening and/or closing function may depend on whether a USB transceiver key is located inside or outside the barrier protected space.

In various embodiments, an IO-detection is provided via two antennas and an RF switching element (in other words, an antenna switch). This may enable using a cheap/efficient UWB-IC (integrated circuit) with a limited amount of receiver (RX) and/or transmitter (TX) path.

In the control device in accordance with various embodiments, a UWB transceiver that has a single receiver/transmitter (RX/TX) path may be used, and a UWB shield may not be required.

Figuratively speaking, a barrier that divides the inside from the outside may itself be used as a spatial separator that allows for a placement of a first antenna of the control device inside the barrier, and of a second antenna of the control device outside the barrier.

A switch may be used for activating either the first antenna or the second antenna for a distance measurement (in the UWB related standard IEEE 802.15.4 and the related protocol, the respective distance measurement is also referred to as ranging).

In various embodiments, a protocol implementation is provided for ensuring the secure ranging process during the switching procedure.

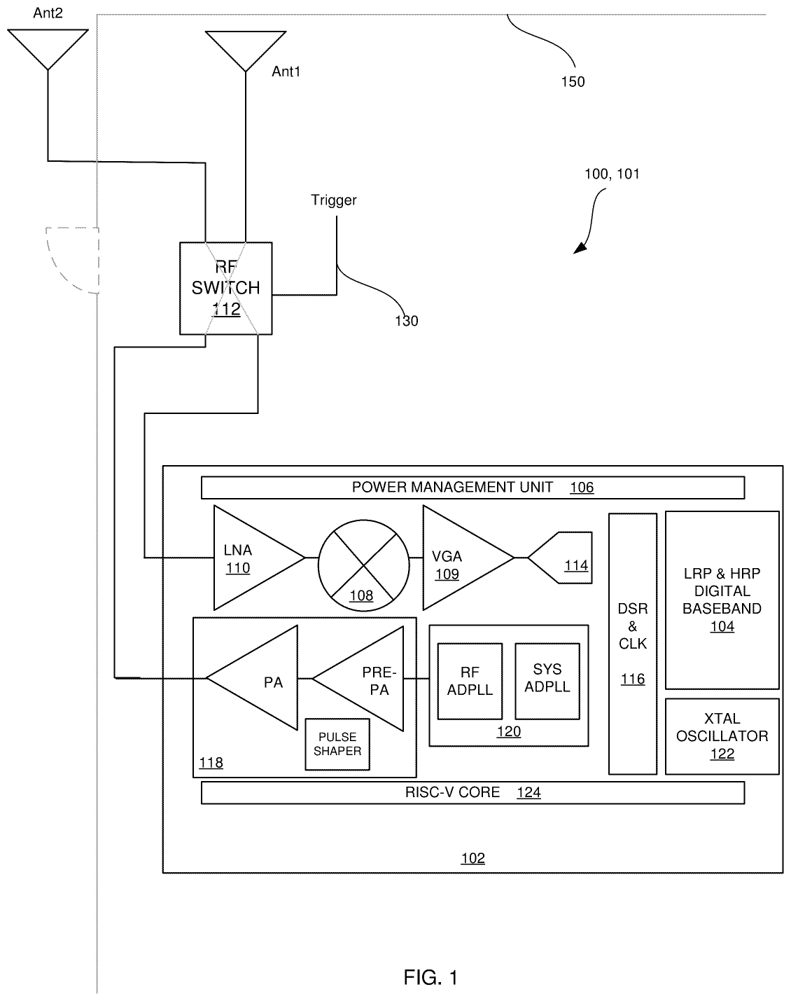

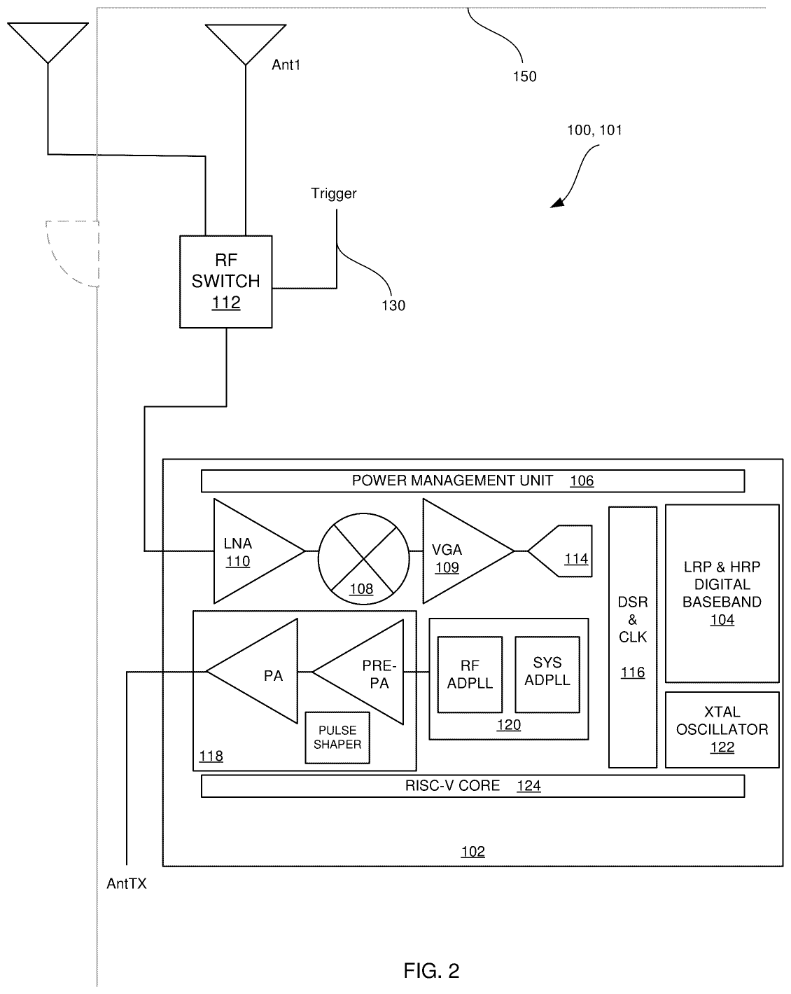

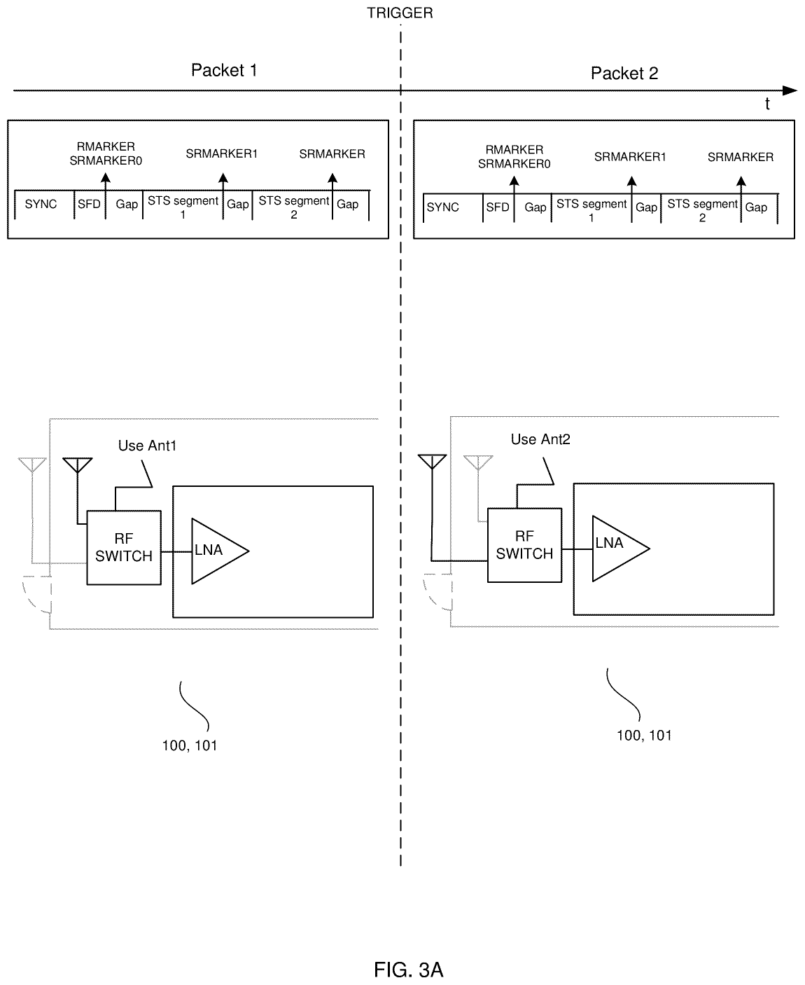

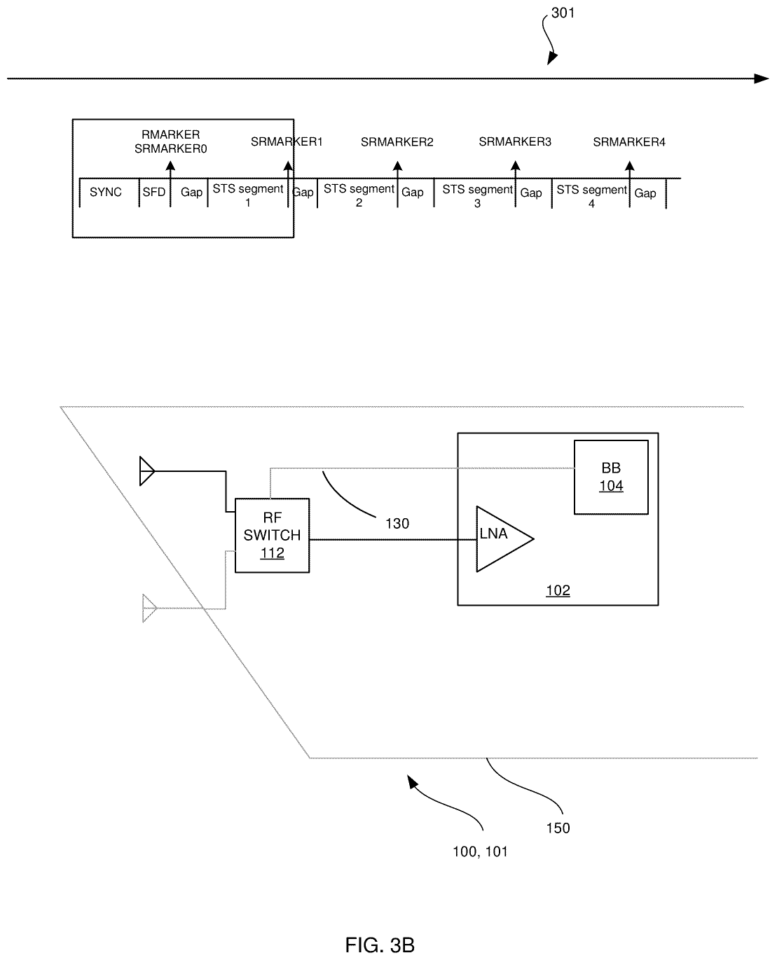

Each of FIGS. 1 and 2 shows a schematic illustration of a control device 100 in accordance with various embodiments, and each of FIGS. 3A to 3C illustrates a position dependent control method in accordance with various embodiments. The control device 100 of FIG. 1 or 2 or a different control device in accordance with various embodiments may be used for executing the control method of FIGS. 3A to 3C.

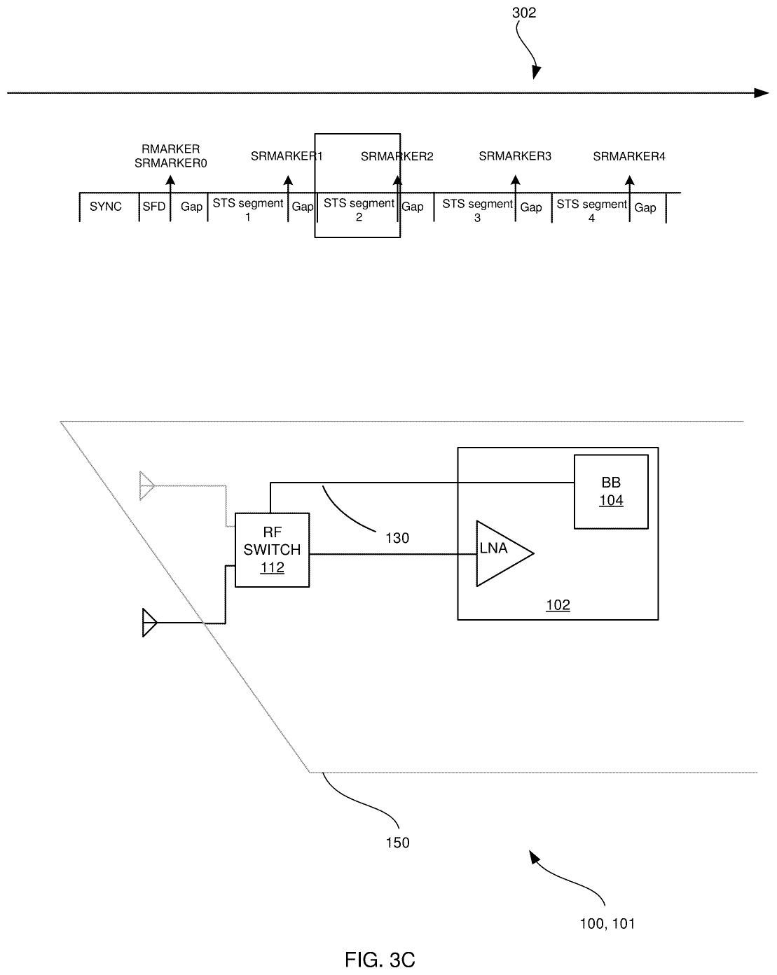

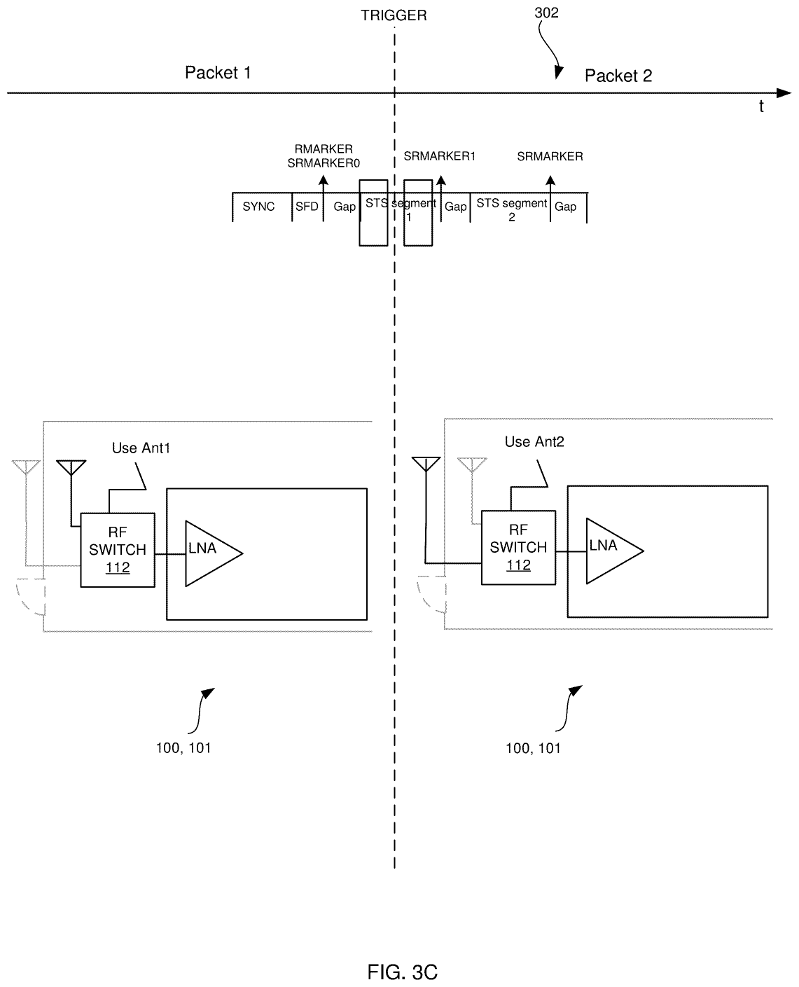

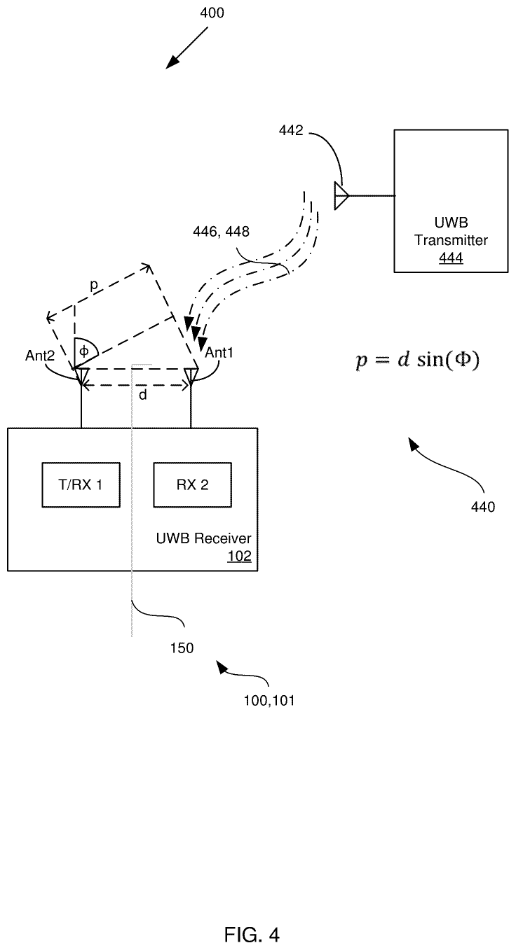

Furthermore, FIG. 4 shows a control system 400 that includes a control device 100 in accordance with various embodiments and a first UWB transceiver 440, wherein the first UWB transceiver 440 may be configured to transmit a UWB packet 446, 448, specifically, a first part 446 of the UWB packet and a second part 448 of the UWB packet.

The control device 100 in accordance with various embodiments includes a second UWB transceiver 101 including a first antenna Ant1 configured to receive a first part 446 of the UWB packet from the first UWB transceiver 440.

The first antenna Ant1 is located inside a barrier 150 protected space. The barrier 150 protected space may be any kind of space for which it may make sense to define an “inside” and an “outside” and to perform an IO detection for determining whether the first UWB transceiver 440 is located inside or outside. The barrier 150 may for example form one or more walls, a bottom, a roof, a window and/or a door, which may in various embodiments

The second UWB transceiver 101 further includes a second antenna Ant2, which is configured to receive a second part 448 of the UWB packet from the first UWB transceiver 440, wherein the second antenna Ant2 is located outside the barrier 150 protected space.

The control device 100 further includes a processor 102 configured to determine a first distance between the first UWB transceiver 440 and the first antenna Ant1 from the first part 446 of the UWB packet, and to determine a second distance between the first UWB transceiver 440 and the second antenna Ant2 from the second part 448 of the UWB packet.

In some of the embodiments, the distance determination process itself may be conducted as a regular ranging process in accordance with the IEEE 802.15.4z standard and protocol. The distance determination may for example be conducted using a round-trip time (RTT) determination (also referred to as two-way ranging), which measures a round-trip time of a signal travelling, for example, from the first antenna Ant1 to an antenna 442 of the first transceiver 440 and back to the first antenna Ant1, or for example, from the second antenna Ant2 to the antenna 442 of the first transceiver 440 and back to the second antenna Ant2.

In various embodiments, the round-trip time may be measured starting either from the first transceiver 440 or from the second transceiver 101, as long as it may be ensured that resulting values of the first distance and of the second distance are present in the second transceiver 101. Thus, results of a distance determining process starting from the first transceiver 440 may be transmitted to the second UWB transceiver 101 in a dedicated transmission or as auxiliary data in a transmission that has a different purpose.

In various embodiments, instead of a round-trip time, a time-of-arrival (TOA) measurement may be employed for the distance measurement, provided that a synchronization between the first UWB transmitter 440 and the second UWB transmitter 101 is conducted first.

In various embodiments, a phase difference measurement as described in context with FIG. 4 may be used for determining the first distance and the second distance.

The processor 102 is further configured to compare a value of the first distance with a value of the second distance, and to determine whether the first UWB transceiver 440 is inside or outside the barrier 150 protected space by determining that the first UWB transceiver 440 is inside the barrier 150 protected space if a result of the comparison indicates that the first distance is smaller than the second distance, and that otherwise the first UWB transceiver 440 is outside the barrier 150 protected space.

The processor 102 further includes a switch 112 configured to connect either the first antenna Ant1 or the second antenna Ant2 with the processor 101, for example with a signal processing portion of the processor 101, which may for example include an amplifier, e. g., a low noise amplifier (LNA) 110, a mixer 108, a variable gain amplifier (VGA) 109, an analog-to-digital-converter (ADC) 114, a clock 116, and a sub-processor 104 for demodulating a digital baseband from its carrier frequency. In various embodiments, except where it is indicated or implicitly otherwise, the signal processing for distance determination may essentially be performed as known in the art, and the processor 102 may include or consist of the respective known parts.

Various types of switches 112 may be used as the (RF-)switch 112. For example, a so-called SPDT switch (Single Pole Double Throw switch) may be used. An SPDT switch may have two inputs (in this case the first antenna Ant1 and the second antenna Ant2) and one output (here, the connection to the processor 102). The SPDT switch 112 may connect either the first antenna Ant1 or the second antenna Ant2 with the output. Since both antennas Ant1, Ant2 are connectable to a receiver portion of the processor 102 only, a further antenna AntTX may be required as a transmitter antenna. A corresponding exemplary embodiment is shown in FIG. 2.

In various embodiments, a DPDT (Double Pole Double Throw) switch may be used as the switch 112. In that case, only two antennas Ant1, Ant2 may be needed for signal reception (RX) and signal transmission (TX), since the switch may connect either the first antenna Ant1 or the second antenna Ant2 to the receiver portion of the processor 102, and the other of the first antenna Ant1 and the second antenna Ant2 to the transmitter portion of the processor 102, which may for example include amplifiers 118, e. g., a power amplifier, a pre-power amplifier and/or a pulse shaper, and phase-locked loop (PLL) components 120, e. g. for an all-digital phase-locked loop (ADPLL), which may essentially correspond to known components in the art. An exemplary embodiment is shown in FIG. 1.

The processor 102 may further include standard components like a power management unit 106, a processor core 124, and an oscillator 122.

The processor 102 may in various embodiments be adapted to execute the method in accordance with various embodiments, for example for providing a trigger to the switch 112 and for analyzing measured distance values.

The terms “first antenna” and “second antenna” are not intended to represent a sequence or ranking of the antennas. These terms are mainly intended to facilitate a distinction between the two antennas. However, for ease of reference, the first antenna is described herein as the antenna that is located inside the barrier protected space, and the second antenna is described herein as the antenna that is located outside the barrier protected space. Thus, even though the method may be described as determining the first distance (to the first antenna) first, and thereafter the second distance (to the second antenna), it may in fact be the other way around.

Thus, in various embodiments, the switching between the first antenna Ant1 and the second antenna Ant2 may include a switching from the first antenna Ant1 to the second antenna Ant2 between the receiving the first part 446 of the UWB packet and the receiving the second part 448 of the UWB packet, or a switching from the second antenna Ant2 to the first antenna Ant1 between the receiving the second part 448 of the UWB packet and the receiving the first part 446 of the UWB packet.

Each of FIGS. 3A to 3C indicates in its top portion a data structure of a data transmission according to an IEEE 802.15.4 standard protocol. The data structure for transmission according to the protocol typically includes an initial synchronization portion (SYNC) for synchronizing the communicating transceivers, a Start Frame Delimiter (SFD) marking a beginning of a data frame, and the data transmission.

The UWB packet 446, 448 may include a scrambled timestamp sequence (STS) signal.

The STS signal may be transmitted as a plurality of segments, which may be separated by gaps.

Markers (indicated as RMARKER and SRMARKERx (wherein x is a number)) may be provided before each gap.

The data structure according to the IEEE 802.15.4 standard protocol provides various possibilities for switching between the first antenna Ant1 and the second antenna Ant2.

In various embodiments, a data transmission between the first UWB transceiver 440 and the first antenna Ant1 may be completed (and, optionally, the distance between the first UWB transceiver 440 and the first antenna Ant1 may be determined) before a trigger is sent to the switch 112 for switching from the first antenna Ant1 to the second antenna Ant2, for which another complete data transmission is executed, including the determining the distance between the first UWB transceiver 440 and the second antenna Ant2. Distance determination may for example be conducted as one of the above-described ranging processes. A corresponding exemplary embodiment is shown in FIG. 3A.

In various embodiments, a data transmission between the first UWB transceiver 440 and the first antenna Ant1 may be initiated and pursued up to a gap after one of the data (e. g., STS data) segments, e. g., the first segment. The data transmitted up to that point in time may be sufficient for determining the distance between the first UWB transceiver 440 and the first antenna Ant1. During the gap, the trigger may be sent for activating the switch 112 for switching from the first antenna Ant1 to the second antenna Ant2, and data transmission continues after the gap with the subsequent (e. g., second) segment, up to the completion of data transmission. Data transmission during the subsequent segment may allow for determining the distance between the first UWB transceiver 440 and the second antenna Ant2. Distance determination may for example be conducted as one of the above-described ranging processes. A corresponding exemplary embodiment is shown in FIG. 3B (which has two parts, FIG. 3B—1/2 and FIG. 3B—2/2).

In various embodiments, a data transmission between the first UWB transceiver 440 and the first antenna Ant1 may be initiated and pursued up to at least a portion of one of the data (e. g., STS data) segments, e. g., the first segment. The data transmitted up to that point in time may be sufficient for determining the distance between the first UWB transceiver 440 and the first antenna Ant1. During the data transmission segment, for example at a predefined specific point in time, the trigger may be sent for activating the switch 112 for switching from the first antenna Ant1 to the second antenna Ant2, and data transmission may continue after the switching with the remainder of the segment. A corresponding exemplary embodiment is shown in FIG. 3C. The timing of the switching may be essential, it may for example be performed in the middle of the data transmission, e. g., a data packet, for example after 32 μs after the Start Frame Delimiter (SFD).

FIG. 4 illustrates a determining of a phase difference between parts of a control device in accordance with various embodiments. The phase difference may in various embodiments (e. g., in embodiments where the switching is performed in a gap between two data segments or in a gap between synchronization and the first data segment; the phase difference method may not work with legacy packets (SPO)) be used instead of determining directly the first distance and the second distance. Here, the distance between the first UWB transceiver 440 and only one of the antennas, e. g., the first antenna Ant1, may be determined, and the second distance may be determined from the first distance and a separation d between the first antenna Ant1 and the second antenna Ant2 as determined from a phase difference p between the first antenna Ant1 and the second antenna Ant2 and an Angle of Arrival ¢. For determining the phase difference of arrival (PDoA), In-Phase (I) components representing a component of the signal that is in phase with a reference signal and Quadrature (Q) components representing the component of the signal that is 90 degrees out of phase with the reference signal may need to be accessible for both data transmission parts, e. g., data packet parts, i. e., the data transmission part transmitted between the first UWB transceiver 440 and the first antenna Ant1, and the data transmission part transmitted between the first UWB transceiver 440 and the second antenna Ant2. A combination of I and Q components (also referred to as IQ data) may provide a complete representation of the signal in the complex plane and thus allow determining amplitude and phase information and therefrom phase difference p and separation d.

The trigger signal for activating the switch 112 for switching between the first antenna Ant1 and the second antenna Ant2 may for example be provided by a GPIO connector of the processor 102. Since, for data analysis, it may be relevant that the switching is to be performed specifically within a gap or within a segment, precise timing may be required.

For example, the gaps may have a length of about 1 μs, which means that for an RF switching that is to be performed within a gap, an RF switching time may have to be less than 1,025 μs.

In various embodiments, the strict timing requirements may mean that the trigger signal may not be provided by a controller of the control device 100, but rather may need to be provided by the digital baseband block 104 (this is indicated in FIG. 3B). The trigger may for example be placed after the RMARKER or after the SRMARKER1.

Even though it is described herein that the determining the first distance and the determining the second distance and/or the comparing of the values of the first distance and the second distance may be performed by the processor 102 of the second UWB transceiver 101 of the control device 100, it may be understood that any or all of these functions may instead be executed in the first UWB transceiver 440, and results may be transmitted to the second UWB transceiver 101.

The control device 100 may further include a functional element (not shown) that may be configured to control a function depending on a position determined for the first UWB transceiver 440.

For example, the functional element may include a lock that may enable or disable access to the barrier 150 protected space, and an activation/deactivation of the lock, which may for example be requested by the first UWB transceiver 440, may be granted or denied by the control device 100 based on whether the first UWB transceiver 440 is determined to be inside or outside of the barrier 150 protected space.

A combination of the first UWB transceiver 440 and the control device 100 may be considered to form a control system.

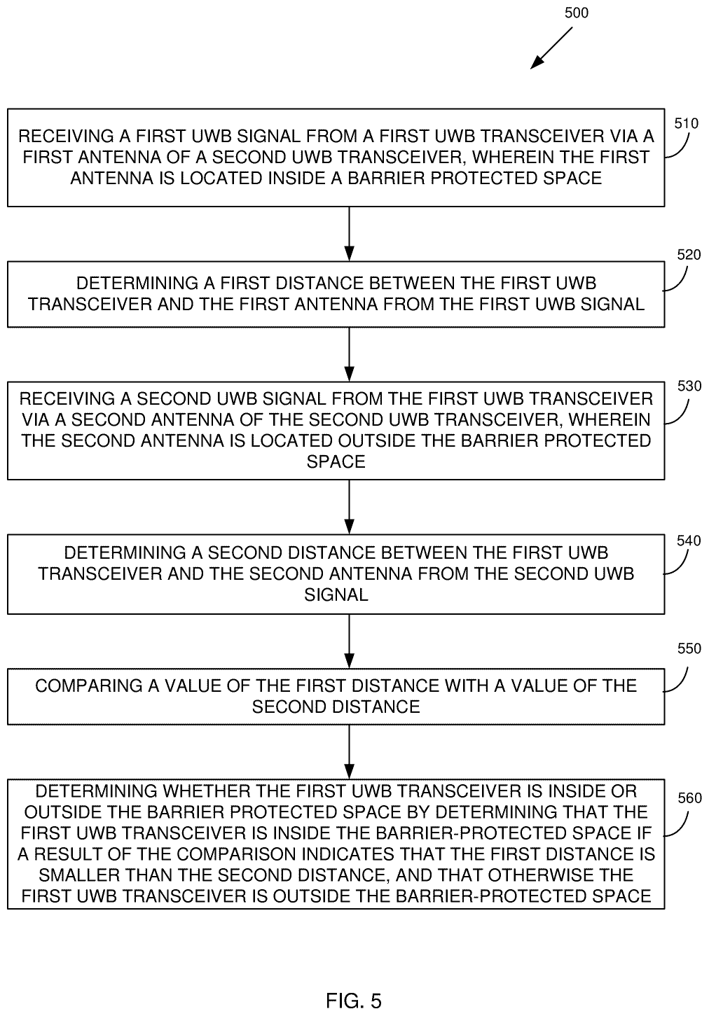

FIG. 5 shows a flow diagram 500 of a position dependent control method in accordance with various embodiments.

The method includes receiving a first part 446 of the UWB packet from a first UWB transceiver via a first antenna of a second UWB transceiver, wherein the first antenna is located inside a barrier protected space (510), determining a first distance between the first UWB transceiver and the first antenna from the first part 446 of the UWB packet (520), receiving a second part 448 of the UWB packet from the first UWB transceiver via a second antenna of the second UWB transceiver, wherein the second antenna is located outside the barrier protected space (530), determining a second distance between the first UWB transceiver and the second antenna from the second part 448 of the UWB packet (540), comparing a value of the first distance with a value of the second distance (550), and determining whether the first UWB transceiver is inside or outside the barrier protected space by determining that the first UWB transceiver is inside the barrier protected space if a result of the comparison indicates that the first distance is smaller than the second distance, and that otherwise the first UWB transceiver is outside the barrier protected space (560).

Several Examples are provided in the following:
Example 1 is a position dependent control method. The method includes receiving a first part 446 of the UWB packet from a first UWB transceiver via a first antenna of a second UWB transceiver, wherein the first antenna is located inside a barrier protected space, determining a first distance between the first UWB transceiver and the first antenna from the first part 446 of the UWB packet, receiving a second part 448 of the UWB packet from the first UWB transceiver via a second antenna of the second UWB transceiver, wherein the second antenna is located outside the barrier protected space, determining a second distance between the first UWB transceiver and the second antenna from the second part 448 of the UWB packet, comparing a value of the first distance with a value of the second distance, and determining whether the first UWB transceiver is inside or outside the barrier protected space by determining that the first UWB transceiver is inside the barrier protected space if a result of the comparison indicates that the first distance is smaller than the second distance, and that otherwise the first UWB transceiver is outside the barrier protected space.
In Example 2, the subject matter of Example 1 may optionally further include a switching between the first antenna and the second antenna, including a switching from the first antenna to the second antenna between the receiving the first part 446 of the UWB packet and the receiving the second part 448 of the UWB packet, or a switching from the second antenna to the first antenna between the receiving the second part 448 of the UWB packet and the receiving the first part 446 of the UWB packet.
In Example 3, the subject matter of Example 1 or 2 may optionally further include that the UWB packet 446, 448 includes a scrambled timestamp sequence (STS) signal.
In Example 4, the subject matter of Example 3 may optionally further include that the first part 446 of the UWB packet and/or the second part 448 of the UWB packet are provided and received as parts of at least one STS segment, with a switching between the first antenna and the second antenna executed during the receiving the UWB packet.
In Example 5, the subject matter of Example 3 or 4 may optionally further include that the switching between the first antenna and the second antenna is executed in a gap between STS segments, e. g., between a first STS segment and a second STS segment.
In Example 6, the subject matter of Example 3 or 4 may optionally further include that the switching between the first antenna and the second antenna is executed within an STS segment.
In Example 7, the subject matter of any of Examples 1 to 6 may optionally further include that the received first part 446 of the UWB packet and the received second part 448 of the UWB packet are transmitted along a common path between a switch for switching between the first UWB antenna and the second UWB antenna and a processor for determining the first distance and the second distance.
In Example 8, the subject matter of any of Examples 1 to 7 may optionally further include that a barrier of the barrier protected space intersects a line-of-sight between the first antenna and the second antenna.
In Example 9, the subject matter of any of Examples 1 to 8 may optionally further include controlling a function based on a result of the determining that the first UWB transceiver is inside the barrier protected space if a result of the comparison indicates that the first distance is smaller than the second distance, and that otherwise the first UWB transceiver is outside the barrier protected space.
Example 10 is a control device. The control device includes a second UWB transceiver including a first antenna configured to receive a first part 446 of the UWB packet from a first UWB transceiver, wherein the first antenna is located inside a barrier protected space, and a second antenna configured to receive a second part 448 of the UWB packet from the first UWB transceiver, wherein the second antenna is located outside the barrier protected space, a processor configured to determine a first distance between the first UWB transceiver and the first antenna from the first part 446 of the UWB packet, to determine a second distance between the first UWB transceiver and the second antenna from the second part 448 of the UWB packet, to compare a value of the first distance with a value of the second distance, and to determine whether the first UWB transceiver is inside or outside the barrier protected space by determining that the first UWB transceiver is inside the barrier protected space if a result of the comparison indicates that the first distance is smaller than the second distance, and that otherwise the first UWB transceiver is outside the barrier protected space, and a switch configured to connect either the first antenna or the second antenna with the processor.
In Example 11, the subject matter of Example 10 may optionally further include that the switch is further configured to switch between the first antenna and the second antenna, including either a switching from the first antenna to the second antenna between the receiving the first part 446 of the UWB packet and the receiving the second part 448 of the UWB packet, or a switching from the second antenna to the first antenna between the receiving the second part 448 of the UWB packet and the receiving the first part 446 of the UWB packet.
In Example 12, the subject matter of Example 10 or 11 may optionally further include that the UWB packet 446, 448 of the UWB packet includes a scrambled timestamp sequence (STS) signal.
In Example 13, the subject matter of any of Examples 10 to 12 may optionally further include that the first part 446 of the UWB packet and/or the second part 448 of the UWB packet are provided as parts of at least one STS segment.
In Example 14, the subject matter of Example 12 or 13 may optionally further include that the switch is configured to switch between the first antenna and the second antenna during receiving the UWB packet.
In Example 15, the subject matter of Example 12 or 13 may optionally further include that the switch is configured to switch between the first antenna and the second antenna within an STS segment.
In Example 16, the subject matter of any of Examples 10 to 15 may optionally further include a common path between the switch and the processor, wherein the common path is configured to transmit the received first part 446 of the UWB packet and the received second part 448 of the UWB packet.
In Example 17, the subject matter of any of Examples 10 to 16 may optionally further include that a barrier of the barrier protected space intersects a line-of-sight between the first antenna and the second antenna.
In Example 18, the subject matter of any of Examples 10 to 17 may optionally further include that the processor is further configured to control a function based on a result of the determining that the first UWB transceiver is inside the barrier protected space if a result of the comparison indicates that the first distance is smaller than the second distance, and that otherwise the first UWB transceiver is outside the barrier protected space.
In Example 19, the subject matter of Example 18 may optionally further include that the function includes enabling access to the barrier protected space.
Example 20 is a control system includes the control device of any of Examples 10 to 19, and the first UWB transceiver.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A position dependent control method, comprising:
receiving a first part of a UWB packet from a first UWB transceiver via a first antenna of a second UWB transceiver, wherein the first antenna is located inside a barrier protected space;
determining a first distance between the first UWB transceiver and the first antenna based on the first part of the UWB packet;
receiving a second part of the UWB packet from the first UWB transceiver via a second antenna of the second UWB transceiver, wherein the second antenna is located outside the barrier protected space;
determining a second distance between the first UWB transceiver and the second antenna based on the second part of the UWB packet;
comparing the first distance with the second distance; and
determining that the first UWB transceiver is inside the barrier protected space when the first distance is smaller than the second distance, and that otherwise the first UWB transceiver is outside the barrier protected space.

2. The position dependent control method of claim 1, further comprising
switching from the first antenna to the second antenna between the receiving of the first part of the UWB packet and the receiving of the second part of the UWB packet, or
switching from the second antenna to the first antenna between the receiving of the second part of the UWB packet and the receiving of the first part of the UWB packet.

3. The position dependent control method of claim 1, wherein the UWB packet includes a scrambled timestamp sequence (STS) signal.

4. The position dependent control method of claim 3, wherein the first part of the UWB packet or the second part of the UWB packet are parts of at least one STS segment, with a switching between the first antenna and the second antenna executed during the receiving of the UWB packet.

5. The position dependent control method of claim 3, wherein the switching between the first antenna and the second antenna is executed in a gap between STS segments.

6. The position dependent control method of claim 3, wherein the switching between the first antenna and the second antenna is executed within an STS segment.

7. The position dependent control method of claim 1, wherein the first part of the UWB packet and the second part of the UWB packet are transmitted along a common path between a switch for switching between the first UWB antenna and the second UWB antenna and a processor for determining the first distance and the second distance.

8. The position dependent control method of claim 1, wherein a barrier of the barrier protected space intersects a line-of-sight between the first antenna and the second antenna.

9. The position dependent control method of claim 1, further comprising controlling a function based on determining whether the first UWB transceiver is inside the barrier protected space.

10. A control device, comprising:
a second UWB transceiver comprising:
a first antenna configured to receive a first part of a UWB packet from a first UWB transceiver, wherein the first antenna is located inside a barrier protected space; and
a second antenna configured to receive a second part of the UWB packet from the first UWB transceiver, wherein the second antenna is located outside the barrier protected space;
a processor configured to:
determine a first distance between the first UWB transceiver and the first antenna based on the first part of the UWB packet;
determine a second distance between the first UWB transceiver and the second antenna based on the second part of the UWB packet;
compare the first distance with the second distance; and
determine that the first UWB transceiver is inside the barrier protected space when the first distance is smaller than the second distance, and that otherwise the first UWB transceiver is outside the barrier protected space; and
a switch configured to connect either the first antenna or the second antenna with the processor.

11. The control device of claim 10, wherein the switch is further configured to
switch from the first antenna to the second antenna between the receiving of the first part of the UWB packet and the receiving the second part of the UWB packet, or
switch from the second antenna to the first antenna between the receiving of the second part of the UWB packet and the receiving of the first part of the UWB packet.

12. The control device of claim 10, wherein the UWB packet includes a scrambled timestamp sequence (STS) signal.

13. The control device of claim 10, wherein the first part of the UWB packet and/or the second part of the UWB packet are parts of at least one STS segment.

14. The control device of claim 12, wherein the switch is configured to switch between the first antenna and the second antenna in a gap between STS segments.

15. The control device of claim 12, wherein the switch is configured to switch between the first antenna and the second antenna within an STS segment.

16. The control device of claim 10, wherein the switch is configured to switch between the first antenna and the second antenna in response to a trigger signal.

17. The control device claim 10, wherein a barrier of the barrier protected space intersects a line-of-sight between the first antenna and the second antenna.

18. The control device of claim 10, wherein the processor is further configured to control a function based on whether the first UWB transceiver is inside the barrier protected space or outside the barrier protected space.

19. The control device of claim 18, wherein the function includes enabling access to the barrier protected space.

20. The control device of claim 10, wherein the switch is configured to switch between the first antenna and the second antenna in response to a trigger generated by a baseband block based on markers in the received UWB packet.
